(19) United States
(12) Patent Application Publication
(10) Pub. No.: US 2005/0208977 A1
(43) Pub. Date: Sep. 22, 2005

(54) Information processing apparatus and software

(75) Inventors: Yasuhisa Mori, Hitachi (JP); Takuya Sugiyama, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/061,078

(22) Filed: Feb. 18, 2005

(30) Foreign Application Priority Data
Mar. 17, 2004 (JP) 2004-075555

(51) Int. Cl. H04M 1/00

(52) U.S. Cl. 455/564; 455/566

(57) ABSTRACT

The information processing apparatus according to the present invention comprises a phone book database and a key input section. The phone book database stores the associations between phone numbers and keywords related to the phone numbers. The key input section contains keys to which characters and numerals are assigned. When a key is pressed, the information processing apparatus reads keywords, which begin with a character assigned to the pressed key, from the phone book database, and displays the read keywords. The information processing apparatus also displays a numeral that is assigned to the pressed key. When a selection is made to dial one of the displayed keywords, the information processing apparatus dials a phone number corresponding to the selected keyword. When keys in the key input section are repeatedly pressed, the numerals assigned to the pressed keys are displayed next to the currently displayed numeral. When the resulting string of numerals corresponds to a certain phone number and a selection is made to dial that number, the information processing apparatus exercises control so that such a phone number can be dialed.

### CROSS-REFERENCES TO RELATED APPLICATIONS

The present application is related to and claims priority from Japanese Patent Application No. 2004-075555, filed Mar. 17, 2004, and is hereby incorporated by reference for all purposes.

### BACKGROUND OF THE INVENTION

The present invention relates to an information processing apparatus and software for dialing a phone number.

A conventional technology disclosed, for instance, by Japanese Patent Laid-Open No. 163999/1999 provides a telephone that enables the user to easily conduct a phone book search without having to perform a complicated procedure. This telephone retrieves names containing a character assigned to a key that is depressed for a period longer than predetermined, and causes a display section to list the retrieved names.

When the user initiates a call using a name in a phone book incorporated in a terminal that has a keyboard configured so as to assign characters and numeral to a single key with a view toward providing increased space savings, it is necessary to first perform a procedure for activating the functionality of the phone book. Even after the phone book functionality is activated, the user has to view the screen contents to locate a desired call destination. Therefore, it is not easy to dial a desired call destination. More specifically, the procedure for reaching a desired call destination is not intuitive.

To conduct a phone book search from a standby screen during the use of the above conventional technology, however, it is necessary to depress a key for a period longer than predetermined. Further, the above conventional technology cannot initiate a phone call by entering a phone number while a phone book search is conducted. Furthermore, it is impossible to conduct a phone book search while a phone number is entered to initiate a phone call.

### BRIEF SUMMARY OF THE INVENTION

The present invention provides an information processing apparatus and software for offering enhanced user-friendliness. An information processing apparatus and software according to the present invention comprises a phone book database and a key input section. The phone book database stores the associations between phone numbers and keywords related to the phone numbers. The key input section contains keys to which characters and numerals are assigned. When a key is pressed, the present invention reads keywords, which begin with a character assigned to the pressed key, from the phone book database, and displays the read keywords. The present invention also displays a numeral that is assigned to the pressed key. When a selection is made to dial one of the displayed keywords, a phone number corresponding to the selected keyword is dialed. When keys in the key input section are repeatedly pressed, the numerals assigned to the pressed keys are displayed next to the currently displayed numeral. When the resulting string of numerals corresponds to a certain phone number and a selection is made to dial that number, the present invention exercises control so that such a phone number can be dialed.

As a result, there is no distinction between dialing a phone number selected from the phone book and dialing an entered phone number. Typical keywords include names, their abbreviations, pet names, and nicknames. The present invention makes it easy to dial a phone number and provides a highly user-friendly information processing apparatus and software.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating the configuration of an embodiment of the present invention;

FIG. 2 shows a first example of keyboard configuration;

FIG. 3 shows a typical phone book database structure;

FIG. 4 shows an operation example of a first embodiment of the present invention;

FIG. 5 shows a typical conversion table structure;

FIG. 6 shows a typical effective digit count list structure;

FIG. 7 shows a first operation example of a second embodiment of the present invention;

FIG. 8 shows a second operation example of the second embodiment of the present invention;

FIG. 9 shows an operation example of a fifth embodiment of the present invention;

FIG. 10 shows a typical special number list structure;

FIG. 11 shows an operation example of a third embodiment of the present invention;

FIG. 12 shows a typical call destination candidate count display;

FIG. 13 shows a second example of keyboard configuration;

FIG. 14 shows an operation example of a fourth embodiment of the present invention; and

FIG. 15 is a block diagram illustrating the configuration of the fifth embodiment of the present invention.

### DETAILED DESCRIPTION OF THE INVENTION

Embodiments of the present invention will now be described with reference to the accompanying drawings. In the drawings, like elements are designated by the same reference numerals.

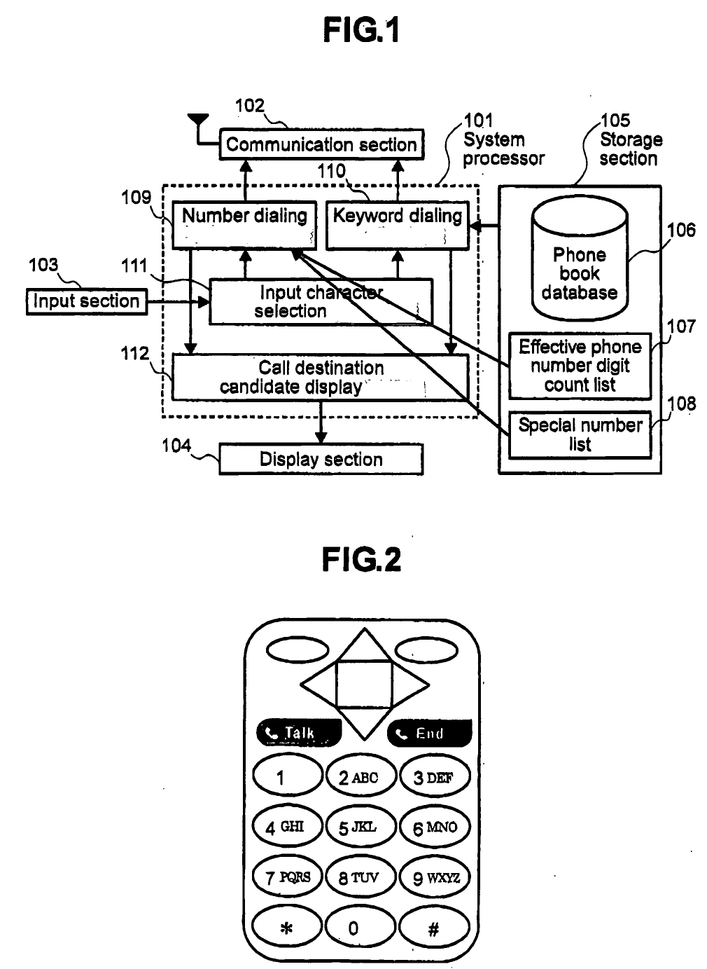

FIG. 1 is a block diagram illustrating a first embodiment of a cellular phone. The reference numeral 101 denotes a system processor. The system processor 101 comprises a CPU, a ROM in which a program is stored, and a RAM in which the data necessary for program execution is stored, implements various functions, which are described later, implements various devices, and provides control over the devices. The reference numeral 102 denotes a communication section, which establishes communication with a base station. The reference numeral 103 denotes an input section 103, which enters the user's instructions and contains a keyboard, cursor keys, and various buttons. The reference numeral 104 denotes a display section, which displays the execution results of various functions and opens various setup screens. The reference number 105 denotes a storage section, which stores user data, including a phone book database 106. The phone book database 106 stores the associations between phone numbers and phone number owner names. Although an effective phone number digit count list 107 and a special number list 108 are also shown in the figure, they are not described herein because they are not essential to the configuration of the present embodiment.

In FIG. 1, various functions residing within the system processor which is logically represented in the figure by a broken line. The reference numeral 109 denotes a number dialer, which stores a user-entered number, handles a stored numeral string as a phone number upon receipt of a call instruction from the user, and causes the communication section 102 to dial the phone number.

The reference numeral 110 denotes a keyword dialer, which stores a user-entered character string and retains candidates that are included in the results of a phone book database 106 search for names beginning with the currently stored character string. When the user selects a desired name from among the candidates and issues a call instruction, the keyword dialer 110 retrieves a phone number corresponding to the selected name from the phone book database 106 and causes the communication section 102 to dial the phone number.

The reference numeral 111 denotes an input character selector, which selects an appropriate number or character in accordance with key information entered from the input section 103, and enters a character code into the number dialer 109 and keyword dialer 110. The details will be described later together with a concrete example.

The reference numeral 112 denotes a call destination candidate display function, which causes the display section 104 to display numeral string information retained by the number dialer 109 and call destination candidates retained by the keyword dialer 110. The details will be described later together with a concrete example.

The overall processing flow according to the present embodiment will now be described with reference to a concrete example.

FIG. 2 illustrates a keyboard that is employed as the input section 103 according to the present embodiment. It contains cursor keys for scrolling, functional keys (Talk and End) for starting/terminating a telephone conversation, numeral/character keys for entering numerals and characters, and special keys (# and *). The numeral/character keys shown in FIG. 2 are marked with numerals and characters. It means that all the marked numerals and characters are assigned to the keys. For example, a key to which the numeral “2” is assigned is also assigned the characters “A”, “B”, and “C”.

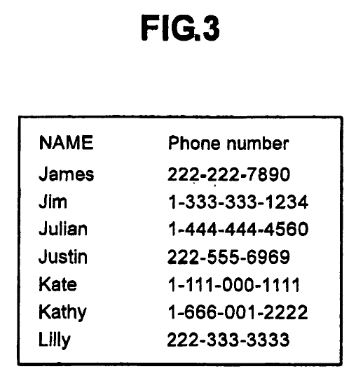

FIG. 3 shows the contents of the phone book database 106, which are used to facilitate the description of the present embodiment. This figure indicates that names are registered as the keywords for respective phone numbers.

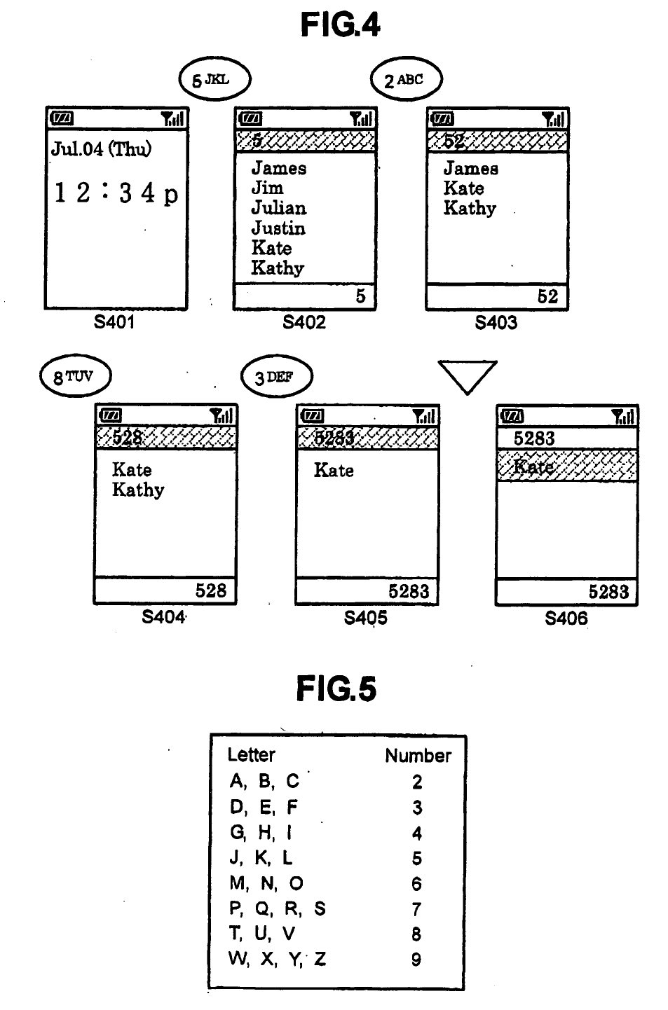

FIG. 4 shows screen contents to indicate how the call destination candidates change in accordance with each user input.

A common cellular phone has an initial screen, which opens upon power ON or when nothing has been entered for a predetermined period of time. This screen is generally referred to as the standby screen. Screen S401 is a typical standby screen. The input character selector 111 according to the present invention begins to stand by for an input from the input section 103 the moment the initial screen opens.

If, for instance, the user presses a key to which the numeral “5” is assigned, the input character selector 111 receives an input instruction and enters “5” into the number dialer 109 and “5”, “J”, “K”, and “L” into the keyword dialer 110.

The number dialer 109 receives an input from the input character selector 111, instructs the call destination candidate display function 112 to display the numeral string “5”, and retains this numeral string as a call destination candidate.

The keyword dialer 110 receives an input from the input character selector 111, searches the phone book database 106 for entries beginning with “5”, “J”, “K”, or “L”, retrieves matching entries as call destination candidates, instructs the call destination candidate display function 112 to display the call destination candidates, and retains the call destination candidates. Screen S402 shows the contents of the display section 104 that are displayed by the call destination candidate display function 112. This screen simultaneously shows “James”, “Jim”, “Julian”, “Justin”, “Kate”, “Kathy”, and “Lilly”, which are the candidates nominated by the keyword dialer 110, and the numeral “5”, which is the candidate nominated by the number dialer 109.

Screen S403 shows the contents of the display section 104 that are displayed by the call destination candidate display function 112 when a key to which the numeral “2” is assigned is pressed. In this instance, the input character selector 111 enters “2” into the number dialer 109 and “2”, “A”, “B”, and “C” into the keyword dialer 110.

The number dialer 109 not only instructs the call destination candidate display function 112 to display the numeral string “52”, which is obtained by adding the currently entered numeral to the previously retained numeral string, but also retains the numeral string “52” as a call destination candidate.

The keyword dialer 110 searches the retained call destination candidates to retrieve candidates having a name whose second character is “2”, “A”, “B”, or “C”, issues an instruction for displaying “James”, “Kate”, and “Kathy” as the retrieved candidates, and retains the retrieved candidates.

Screen S404 shows the on-screen result that is obtained when the same processes are performed as indicated above by various functions in response to the press of a key to which the numeral “8” is assigned. More specifically, the screen shows a numeral string, which comprises numerals that have been entered by the number dialer 109, and the results of a search that is conducted by the keyword dialer 110 to search the previous candidates and retrieve candidates whose name has “8”, “T”, “U”, or “V” as the third character.

Screen S405 shows the on-screen result that is obtained when a key to which the numeral “3” is assigned is pressed. The screen now shows “Kate” and “5283” at the same time. “Kate” is displayed because the name of a candidate nominated by the keyword dialer 110 must have a fourth character of “3”, “D”, “E”, or “F”. The number “5283” is displayed because it represents a candidate that is now nominated by the number dialer 109. Screen S406 indicates that the user has selected a call destination with a cursor key because only one candidate is now nominated by the keyword dialer 110. When the user presses a cursor key to move the highlighting to select a call destination and then presses a functional key (Talk) in the input section 103, the cellular phone places a call to the selected call destination. The use of means for allowing the user to make a selection, which is indicated by screen S406, is not limited to the above situation. The means also works when the user presses a cursor key to make a selection from among a plurality of candidates.

In the first embodiment described above, even if only one candidate is eventually nominated by the keyword dialer 110 during a key input process, candidates nominated by the number dialer 109 also exist. Therefore, there are many cases where the user has to make a selection with a cursor key at a final stage. This poses a slight problem that impairs the consistency of an input procedure. Two additional embodiments, which solve such a problem, will now be described.

First, a second embodiment will be described. The second embodiment additionally furnishes the cellular phone with an effective phone number digit count list.

The second embodiment is obtained by adding the effective phone number digit count list 107 to the storage section 105 that is shown in FIG. 1. The special number list 108 is not described in herein because it is not essential to the configuration of the present embodiment.

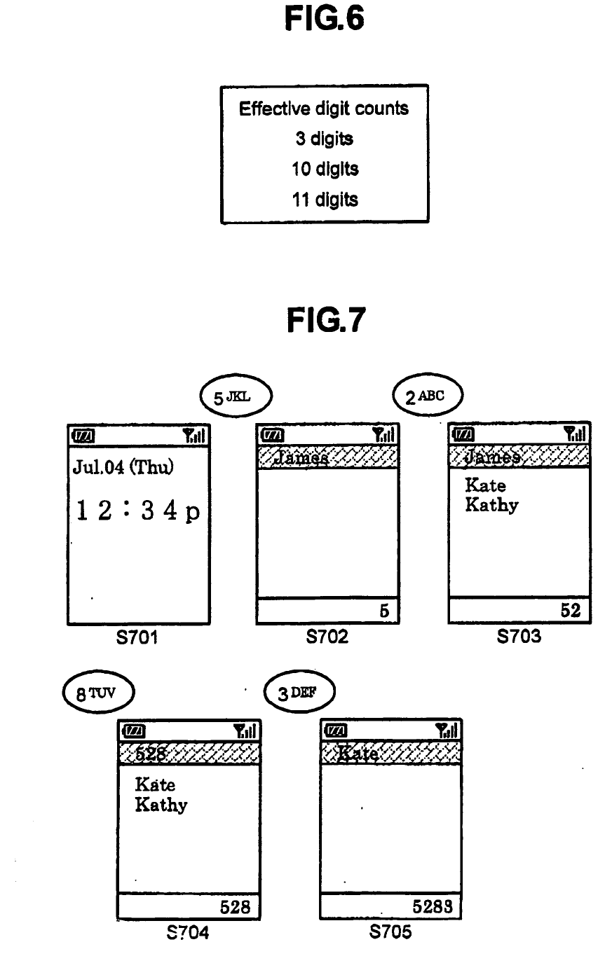

FIG. 6 shows a typical effective phone number digit count list 107. In general, the number of phone number digits is classified into several types depending on the call destination. Under normal conditions, the number of phone number digits is fixed at 10 or 11 (with the toll call indicating digit “1” added to regular 10 digits). For emergencies, three-digit phone numbers are used. Further, when the number of phone numbers for servicing use by a telecommunications provider is fixed, it is possible to formulate the effective phone number digit count list 107. The present embodiment assumes that the effective phone number digit count list 107 has 3, 10, and 11 as the number of phone number digits as shown in FIG. 6.

FIG. 7 shows a case where the present invention is applied to the example shown in FIG. 4. In the present embodiment, means other than the number dialer 109 perform the same operations as described in conjunction with the first embodiment. Upon receipt of an input from the input character selector 111, the number dialer 109 according to the present embodiment checks whether the effective phone number digit count list 107 contains the number of digits for a call destination candidate indicated by the input result. If such a number of digits does not exist in the effective phone number digit count list 107, no display instruction is issued to the call destination candidate display function 112. In screens 702 and 703 in FIG. 7, no call destination candidate is displayed because the number of digits is 1 or 2. Screen 704, however, reads “528” as a call destination candidate because the number of entered digits is 3. However, when “3” is entered next (screen S705), the number of entered digits is 4. Such a number of digits is not found in the effective phone number digit count list. When only one candidate is nominated by the keyword dialer 110 as shown in screen S705, the user can call a desired destination by issuing a dialing instruction.

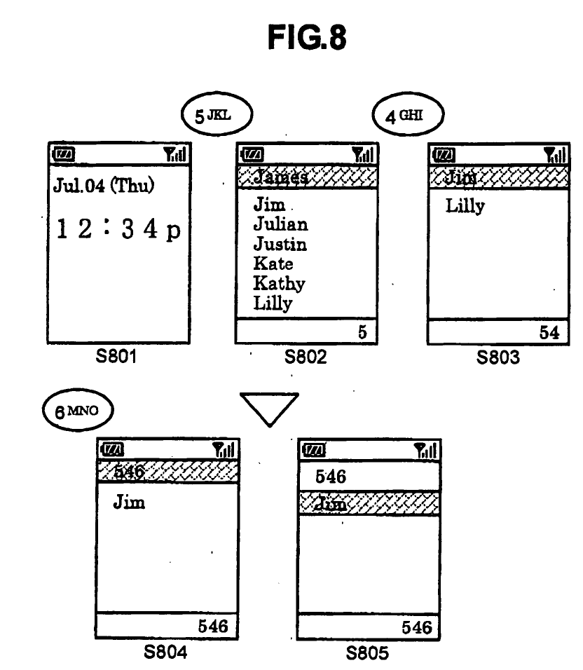

In the second embodiment described above, the user occasionally has to make an ultimate selection with a cursor key. FIG. 8 shows a case where the user attempts to call “Jim” in accordance with the second embodiment.

In this case, the user sequentially enters the numerals “5”, “4”, and “6” in order to select a desired call destination. After completion of numeral input, the candidate “546”, which is nominated by the number dialer 109, exists in addition to the candidate “Jim”, which is nominated by the keyword dialer 10, as shown in screen S804. The reason is that the check performed by the number dialer of the effective phone number digit count list 107 has revealed that a 3-digit phone number is currently effective.

A third embodiment will now be described. The third embodiment further comprises the special number list 108 in order to solve the above problem.

The third embodiment is obtained by adding the special number list 108 to the storage section 105 according to the second embodiment.

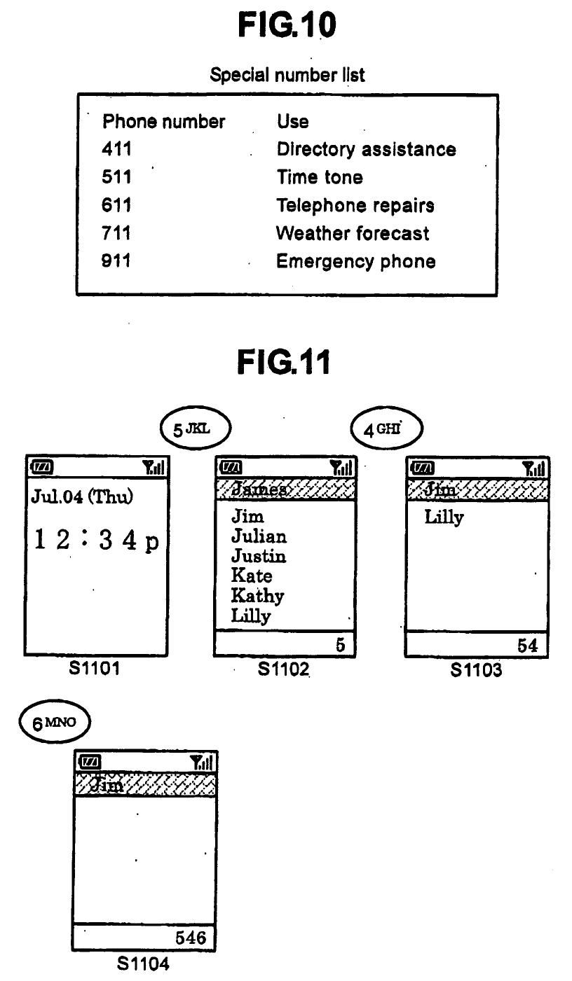

FIG. 10 shows an example of the special number list 108. The special number list 108 contains phone numbers for emergency use and phone numbers containing a small number of digits that a telecommunications provider uses to provide services to the user.

When the third embodiment is applied to the example shown in FIG. 8, “3” is first deleted from the effective phone number digit count list 107 because it represents the number of special number digits. As a result, the effective phone number digit count for the present embodiment is now 10 or 11.

FIG. 11 shows how the call destination candidate display changes when the present invention is applied to the example shown in FIG. 8. Each time a numeral is entered from the input character selector 111, the number dialer 109 first references the effective phone number digit count list 107 to check whether the current number of digits is effective as a phone number. If the current number of digits is not found in the list, the number dialer 109 checks whether the internally retained number exists in the special number list 108. If it exists, the number dialer 109 passes it to the call destination candidate display function 112 as a call destination candidate. If it does not exist, on the other hand, it is not handled as a call destination candidate. This ensures that the candidates can be narrowed down to “Jim”, which is nominated by the keyword dialer 110, as shown in screen S1104.

In the above case, it is anticipated that the number dialer 109 may frequently search the special number list 108. For simplicity of increased process and reducing number of processing steps, it is possible to retain the number of special number digits inside the special number list 108 or elsewhere and run a digit count check before viewing the contents of the special number list 108.

Further, the special number list 108 contains an emergency phone number. Since the emergency phone number is provided for emergency use, it is necessary to achieve call initiation simply by performing a minimum number of steps to enter the phone number. Therefore, when candidates are displayed by the call destination candidate display function 112, a candidate nominated by the number dialer 109 should be displayed in the uppermost position and selected by default.

Due to the product characteristics of the cellular phone, the display section 104 is capable of displaying a limited number of lines. If all call destination candidates nominated by the keyword dialer 110 are displayed in a situation where the present invention is applied to such a cellular phone, the maximum displayable line count may be exceeded depending on the contents of the phone book database 106 so that the user is forced to scroll the screen with a cursor key in order to view all the displayed call destination candidates.

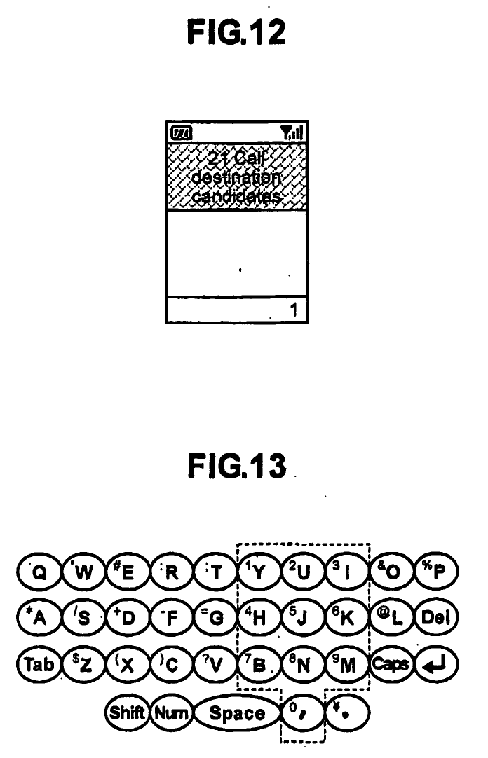

In such an instance, the call destination candidate display function 112 checks whether the maximum displayable line count is exceeded by the number of candidates when it is about to cause the display section 104 to display call destination candidates nominated by the keyword dialer 110. If the maximum displayable line count is exceeded, the call destination candidate display function 112 displays the number of candidates as shown in FIG. 12. While a key-input-based search is conducted, the user can see how the candidates are narrowed down if there are many search results. Thus, increased user friendliness results.

Alternatively, the employed configuration may include the special number list 108 but exclude the effective phone number digit count list 107. This simplifies the configuration, reduces the load on the system, and eases the storage capacity requirements for the storage section.

A fourth embodiment of the present invention will now be described. The input 30 section 103 employed for the fourth embodiment is a keyboard that is configured as shown in FIG. 13. To provide increased ease of character input, this keyboard has such a layout that all alphabetical characters are independently assigned to its keys. For saving increased space, however, numerals are assigned to keys that are used as character keys (the numeric keys are enclosed by a broken line).

The cellular phone according to the present embodiment is configured the same as indicated in FIG. 1. However, the input character selector 111 has an additional function, which does not make an entry into the number dialer 109 if no numeral is assigned to a pressed key of the input section.

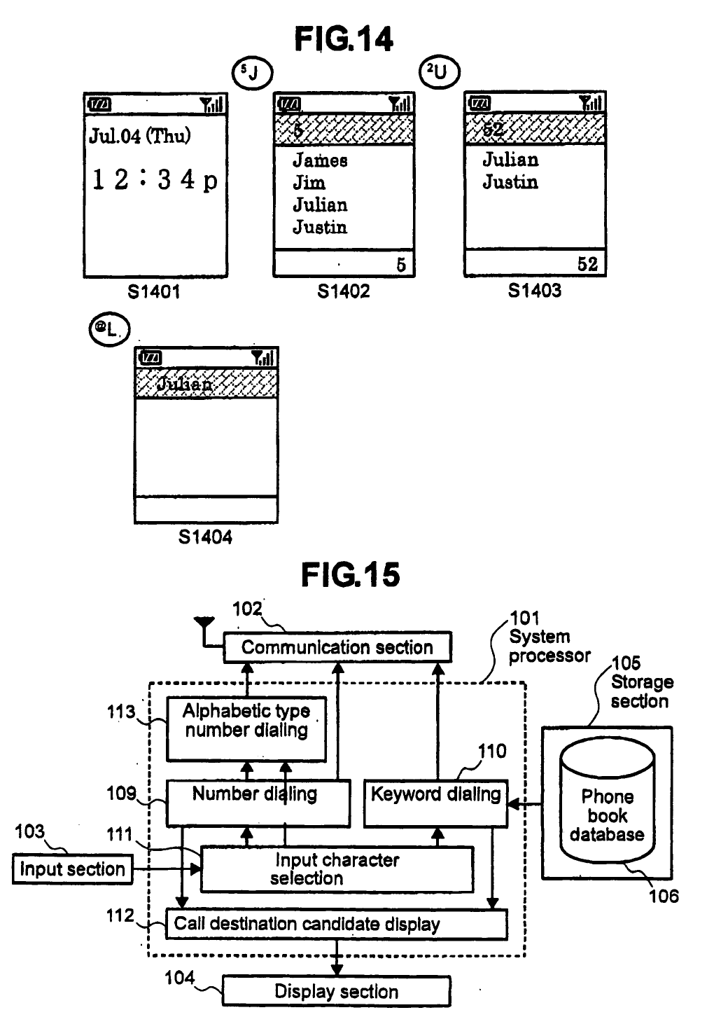

The operation flow according to the present embodiment will now be described with reference to FIG. 14. In the present embodiment, it is assumed that the user attempts to dial a phone number having the keyword “Julian”.

If the user accesses the input section 103 and presses a key to which the character “J” is assigned, the input character selector 111 receives an input instruction and enters the “5”, which is the numeral assigned to the pressed key, into the number dialer 109, and “5” and “j” into the keyword dialer 110.

Upon receipt of the input, the number dialer 109 instructs the call destination candidate display function 112 to display the numeral string “5” and retains this numeral string as a call destination candidate.

Upon receipt of the input from the input character selector 111, the keyword dialer 110 searches the phone book database 106 for keywords beginning with “6” or “j”, retrieves matching candidates as call destination candidates, instructs the call destination candidate display function 112 to display the retrieved call destination candidates, and retains the call destination candidates. Screen S1402 shows the contents that the call destination candidate display function 112 displays on the display section 104. This screen simultaneously shows “5”, which is the candidate nominated by the number dialer 109, and “James”, “Jim”, “Julian”, and “Justin”, which are the candidates nominated by the keyword dialer 110.

Screen S1403 shows candidate changes that are caused when a key to which the character “U” is assigned is pressed next.

The number dialer 109 displays the numeral string “52” as a candidate, which is obtained by adding the numeral input (“2”) from the input character selector 111 to the existing numeral “5”. Further, the number dialer 109 also displays the candidates “Justin” and “Julian”, which are nominated by the keyword dialer 110.

Screen S1404 shows a case where a key to which the character “L” is assigned is pressed. Since no numeral is assigned to the key to which the character “L” is assigned, the input character selector 111 instructs the number dialer 109 to discard the currently retained candidate. As a result of the input of the character “L”, the call destination candidate display function 112 is instructed to display “Julian”, which is a candidate nominated by the keyword dialer 110. Thus, the user can dial a desired call destination.

Finally, a fifth embodiment will now be described. The fifth embodiment comprises an alphabetic type number dialer in order to improve the input efficiency.

FIG. 15 is a block diagram illustrating the fifth embodiment of a cellular phone according to the present invention. The fifth embodiment is obtained by adding the alphabetic type number dialer 113 to the cellular phone according to the first embodiment.

The alphabetic type number dialer 113 is generally used in the U.S. to provide alphabetic display of phone numbers. It is used to help the user memorize a phone number that is disclosed by a corporation or other organization for customers. Such a phone number is indicated by alphabetical characters that are inscribed on general telephone number keys. The user can dial a desired phone number by pressing keys on which target characters are inscribed.

However, when the keyboard configured as shown in FIG. 13 is employed, the alphabetical characters are inscribed at locations different from those for common cellular phones (FIG. 2). Therefore, the user has to perform a complicated procedure because the user needs to convert alphabetical characters to numerals and then dial a number. The alphabetic type number dialer 113 converts alphabetical characters to numerals to provide increased user-friendliness.

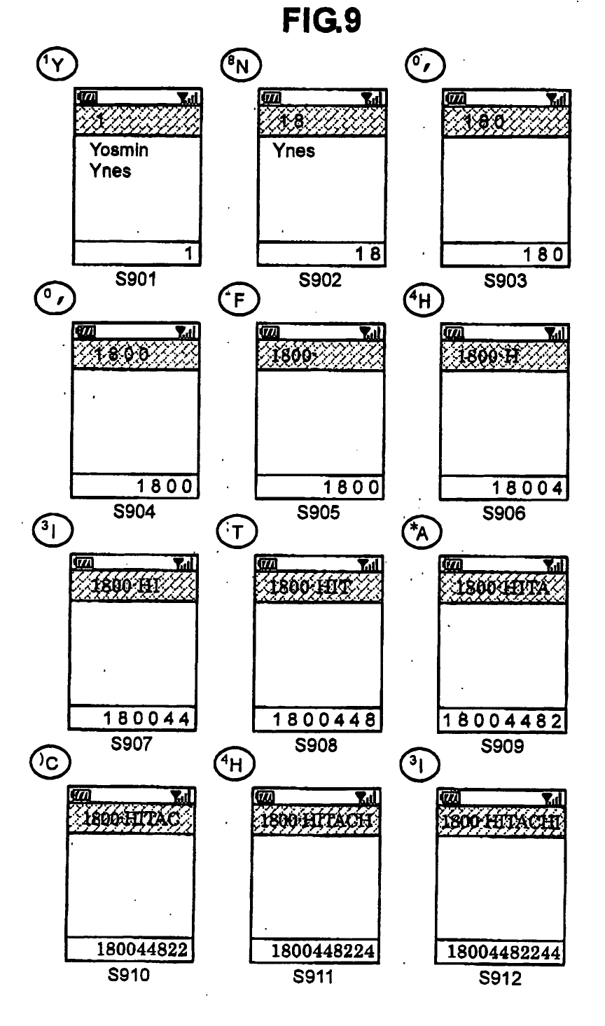

FIG. 9 shows how the screen contents change when the user dials the phone number “1800-HITACHI” with a cellular phone according to the present invention.

First of all, the user presses the “Y”, “N”, “,”, and “,” keys in sequence from the input section 103 in order to enter the numeral string “1800” from the keyboard shown in FIG. 13 (screens S901 to S904). During this key press sequence, various functions within the cellular phone perform the same operations as described earlier. When the user subsequently presses the “F” key to enter a hyphen (-), the input character selector 111 starts the alphabetic type number dialer 113. When started, the alphabetic type number dialer 113 first acquires the call destination candidate “1800”, which is stored in the number dialer 109, then adds a hyphen (-) to the acquired numeral string, instructs the call destination candidate display function 112 to display the resulting string as a call destination candidate, and internally retains the call destination candidate (screen S905).

When the user subsequently presses a key to which the character “H” is assigned, the input character selector 111 enters the character “H” into the alphabetic type number dialer 113. Upon receipt of the character “H”, the alphabetic type number dialer 113 references a conversion table shown in FIG. 5, converts the alphabetical character to a numeral, and internally retains the numeral as a call destination candidate. The alphabetic type number dialer 113 also instructs the call destination candidate display function 112 to display a call destination candidate, which is obtained by adding the entered character to the end of the previously displayed candidate. When the screen contents look like screen S906, the call destination candidate “18004” is internally retained and an instruction for displaying the character string “1800-H” is issued.

When the same operation is subsequently performed as described above in compliance with user input so that the screen contents change from screens S907 to S912, the alphabetic type number dialer 113 eventually displays “1800-HITACHI” as a call destination candidate. When the user issues a dialing instruction, the alphabetic type number dialer 113 converts the displayed string to the phone number “18004482244” and then dials the phone number.

Although the foregoing embodiments uses a cellular phone, which is a mobile communication terminal, as an information processing apparatus, a personal computer may alternatively be used as the information processing apparatus. However, the advantages provided by the foregoing embodiments are greater for cellular phones than for personal computers because the cellular phones have to assign many characters to a single key.

Further, even if the type of characters varies, a search can be conducted without changing the mode. Therefore, increased user-friendliness results.

Furthermore, the foregoing embodiments can be implemented by incorporating software into the information processing apparatus. This eliminates the need for purchasing a new information processing apparatus, thereby reducing the cost.

As regards the order in which the applicable call destination regions are displayed, the foregoing embodiments first display a phone number, which is a numeral string. However, an alternative display order is also applicable. For phone number dialing purposes, it is necessary to perform a keying procedure to enter 8 to 10 digits, which generally constitute a phone number. Phone number dialing does not usually start when up to 7 digits are entered. Therefore, the display shows a keyword first and then a phone number, which is a numeral string. In this manner, a desired call destination can be dialed as soon as possible. However, it is preferred that the display first show the phone number “911” and other emergency phone numbers even when they consist of a small number of digits.

1. An information processing apparatus comprising:
a phone book database comprising a plurality of phone numbers, each phone number being associated with one or more keywords;
an input component comprising a plurality of keys that can be activated by a user, each key being associated with a digit and one or more characters, the keywords comprising an alphanumeric sequence of one or more digits, one or more characters, or a combination of digits and characters;
a display component; and
a processing component operative to respond to activation of one or more of the keys by:
retaining a key-sequence representative of the sequence of keys that are activated;
searching the phone book database to identify a list of matching keywords that begin with an alphanumeric sequence that match an alphanumeric sequence represented by the key-sequence;
displaying the list of matching keywords in a selection area of the display component; and
displaying a sequence of digits represented by the key-sequence in the selection area of the display component,
the processing component further operative to respond to a selection action made on an item displayed in the selection area by dialing the phone number associated with the selected item.

2. The information processing apparatus of claim 1 as incorporated in a cellular phone.

3. The information processing apparatus of claim 1 wherein activation of a key is a keypress action.

4. The information processing apparatus of claim 1 further comprising one or more effective digit counts (EDC's), wherein if the number of keys in the key-sequence is equal to one of the EDC's, then the sequence of digits represented by the key-sequence is displayed in the selection area, and if the the number of keys in the key-sequence is not equal to any of the EDC's, then the sequence of digits represented by the key-sequence is not displayed in the selection area.

5. The information processing apparatus of claim 1 wherein the processing component is further operative to resopnd to activation of an additional key by the user by:
updating the key-sequence to include the additional key, thus producing an updated key-sequence;
updating the list of matching keywords to produce an updated list that contains matching keywords that begin with an alphanumeric sequence that match an alphanumeric sequence represented by the updated key-sequence;
updating the selection area of the display component to display the updated list of matching keywords; and
updating the selection area of the display component to display an updated sequence of digits represented by the updated key-sequence.

6. The information processing apparatus of claim 5 further comprising one or more effective digit counts (EDC's), wherein if the number of keys in the key-sequence is equal to one of the EDC's, then the sequence of digits represented by the key-sequence is displayed in the selection area, and if the the number of keys in the key-sequence is not equal to any of the EDC's, then the sequence of digits represented by the key-sequence is not displayed in the selection area, wherein if the number of keys in the updated key-sequence is equal to one of the EDC's, then the sequence of digits represented by the updated key-sequence is displayed in the selection area, and if the the number of keys in the updated key-sequence is not equal to any of the EDC's, then the sequence of digits represented by the updated key-sequence is not displayed in the selection area.

7. The information processing apparatus of claim 1 further comprising one or more effective digit counts (EDC's) and one or more special numbers,
wherein if the number of keys in the key-sequence is equal to one of the EDC's, then the sequence of digits represented by the key-sequence is displayed in the selection area, and if the the number of keys in the key-sequence is not equal to any of the EDC's, then the sequence of digits represented by the key-sequence is not displayed in the selection area,
wherein if the sequence of digits represented by the key-sequence matches one of the special numbers, then it is displayed in the selection area irrespective of whether its number of digits is equal to one of the EDC's.

8. The information processing apparatus of claim 1 wherein the input component comprises a plurality of second keys, wherein the processing component does not update the key-sequence when any of the second keys is activated.

9. A method for operating an information processing appratus comprising a key-input device, the key-input device comprising a plurality of first keys, each first key being associated with a digit and one or more characters, the method comprising:
detecting activation of one of the first keys, where a sequence of activations is represented by a key-sequence;
in response to the detecting, displaying one or more matching keywords in the phone book having an alphanumeric sequence that matches an alphanumeric sequence represented by the key-sequence;
in further response to the detecting, displaying a sequence of digits represented by the key-sequence; and
detecting a selection of an item comprising one of the matching keywords or the sequence of digits that is displayed, and in response thereto dialing a phone number associated with the selected item.

10. The method of claim 9 further comprising storing one or more effective digit counts (EDC's), wherein if the number of keys in the key-sequence is equal to one of the EDC's then the sequence of digits that is displayed can be selected for dialing, wherein if the number of keys in the key-sequence is not equal to one of the EDC's then the sequence of digits that is displayed can not be selected for dialing.

11. The method of claim 10 further comprising storing one or more special numbers, wherein if the sequence of digits represented by the key-sequence matches one of the special numbers, then it can be selected for dialing irrespective of whether its number of digits is equal to one of the EDC's.

12. A storage medium comprising executable program code, the executable program code configured to cause a data processing unit to operate in accordance with the method of claim 9.

13. The method of claim 9 as incorporated in a cellular phone.

14. The method of claim 9 wherein activation of one of the first keys is a keypress action.

15. The method of claim 9 further comprising one or more effective digit counts (EDC's), wherein if the number of keys in the key-sequence is equal to one of the EDC's, then the sequence of digits represented by the key-sequence is displayed, and if the the number of keys in the key-sequence is not equal to any of the EDC's, then the sequence of digits represented by the key-sequence is not displayed.

16. The method of claim 9 further comprising detecting activation of an additional key from among the first keys and in response thereto:
updating the key-sequence to include the additional key, thus producing an updated key-sequence;
displaying one or more matching keywords that begin with an alphanumeric sequence that match an alphanumeric sequence represented by the updated key-sequence; and
displaying an updated sequence of digits represented by the updated key-sequence.

17. The method of claim 16 further comprising one or more effective digit counts (EDC's), wherein if the number of keys in the key-sequence is equal to one of the EDC's, then the sequence of digits represented by the key-sequence is displayed, and if the the number of keys in the key-sequence is not equal to any of the EDC's, then the sequence of digits represented by the key-sequence is not displayed, wherein if the number of keys in the updated key-sequence is equal to one of the EDC's, then the sequence of digits represented by the updated key-sequence is displayed, and if the the number of keys in the updated key-sequence is not equal to any of the EDC's, then the sequence of digits represented by the updated key-sequence is not displayed.

18. The method of claim 9 further comprising one or more effective digit counts (EDC's) and one or more special numbers,
wherein if the number of keys in the key-sequence is equal to one of the EDC's, then the sequence of digits represented by the key-sequence is displayed, and if the the number of keys in the key-sequence is not equal to any of the EDC's, then the sequence of digits represented by the key-sequence is not displayed,
wherein if the sequence of digits represented by the key-sequence matches one of the special numbers, then it is displayed in the selection area irrespective of whether its number of digits is equal to one of the EDC's.

19. The method of claim 9 wherein the key-input device further comprises a plurality of second keys, wherein the key-sequence is not updated when one of the second keys is activated.
